(19) United States
(12) Patent Application Publication
(10) Pub. No.: US 2011/0316426 A1
(43) Pub. Date: Dec. 29, 2011

(54) AUDIO-VISUAL ENVIRONMENT CONTROL DEVICE, AUDIO-VISUAL ENVIRONMENT CONTROL SYSTEM AND AUDIO-VISUAL ENVIRONMENT CONTROL METHOD

(75) Inventors: Takuya Iwanami, Osaka (JP); Taiji Nishizawa, Osaka (JP); Yasuhiro Yoshida, Osaka (JP); Yasuhiro Ohki, Osaka (JP); Takashi Yoshii, Osaka (JP); Manabu Ishikawa, Osaka (JP)

(73) Assignee: SHARP KABUSHIKI KAISHA, Osaka-shi (JP)

(21) Appl. No.: 12/521,257

(22) PCT Filed: Dec. 25, 2007
(86) PCT No.: PCT/JP2007/074838

§ 371 Date: Aug. 19, 2009

(30) Foreign Application Priority Data
Dec. 28, 2006 (JP) 2006-353876

(51) Int. Cl. H05B 37/02

(52) U.S. Cl. 315/151

(57) ABSTRACT

An illumination device detecting section (6) detects data on the position of each illumination device (7) installed in the audio-visual environment space for a viewer. An illumination control data generating section (9) generates illumination control data for controlling each illumination device installed in the audio-visual environment space for the viewer, with use of the data on the position of each illumination device (7). The illumination control data allows suitable control of each illumination device installed in the audio-visual environment space for the viewer, in correspondence with its installation position, thereby improving the realistic atmosphere obtained by the viewer.

### TECHNICAL FIELD

The present invention relates to an audio-visual environment control device, an audio-visual environment control system including the audio-visual environment control device, and an audio-visual environment control method, each of which enables production of illumination effects such as improvement in the realistic atmosphere created at the time of observing images by controlling illumination light from an illumination device provided in a predetermined space such as an audio-visual environment space.

### BACKGROUND ART

In these years, electronic technologies for images and sounds have been improved rapidly. This leads to enlargement of displays, widening of viewing angles, resolution enhancement, and improvement of surround sound system. This allows users to enjoy realistic images and sounds. For example, home theater systems, which are recently used more and more widely, include a combination of a large display or screen and multiple-channel audio/acoustic technique, thereby providing systems for achieving a highly realistic atmosphere.

Moreover, especially recently, systems including a combination of various media are under considerable development for providing a more realistic atmosphere for users. Examples of such systems that are proposed encompass: a system for viewing wide angle images not by a single display device only, but by a combination of a plurality of displays; and a system in which images on a display and illumination light of an illumination device are linked to operate together.

In particular, the technique including linked operation of the display and the illumination device achieves a highly realistic atmosphere without a large display, thereby reducing restrictions of costs and installation space, for example. These features attract a lot of attention with great expectations.

According to the technique, the illumination light of the plurality of illumination devices installed in a viewer's room (audiovisual environment space) is controlled in color and brightness according to the images displayed on the display. This provides the viewer with such a sense and an effect that as if the viewer exists in the image space displayed on the display. For example, Patent Literature 1 discloses such a technique in which images displayed on a display and illumination light of an illumination deice are linked to operate together.

The technique disclosed in Patent Literature 1 is aimed to provide a highly realistic atmosphere. Patent Literature 1 describes a method for producing illumination control data for a plurality of illumination devices according to features (representative color and average brightness) of image data, in an illumination system for controlling the plurality of illumination devices linked to operate with images to be displayed. More specifically, Patent Literature 1 discloses that a display region for detecting the features of the image data varies according to the installation position of each illumination devices.

Moreover, Patent Literature 1 discloses that the control data may not only be calculated from the features of the image data, but also be delivered either solely or in combination with the image data via, e.g., the Internet or via carrier waves.

### CITATION LIST

Patent Literature 1

Japanese Patent Application Publication, Tokukai, No. 2001-343900 A (Publication Date: Dec. 14, 2001)

### SUMMARY OF INVENTION

Unfortunately, the technique disclosed in Patent Literature 1 above merely generates illumination control data corresponding to a predetermined arrangement of the illumination devices. The technique therefore includes no arrangement of detecting the position of each illumination device installed in an audio-visual environment space so that suitable illumination control data corresponding to the detection result is generated. This prevents suitable illumination control, e.g., when an illumination device or an image display device in the audio-visual environment space is moved, or when an additional illumination device is provided.

The present invention has been accomplished in view of the above problem with the conventional art. It is an object of the present invention to provide an audio-visual environment control device, an audio-visual environment control system, and an audio-visual environment control method, each of which allows suitable illumination control even when, for example, the installation position of an illumination device is changed or when an additional illumination device is provided, and also achieves a suitable illumination effect (e.g., a highly realistic atmosphere).

The present invention solves the above problem with the following technical means:

The present invention provides an audio-visual environment control device for controlling illumination light from at least one illumination device in accordance with features of image data to be displayed by a display device, the audio-visual environment control device including: illumination device position detecting means for detecting each installation position of the at least one illumination device; storing means for storing information on the each installation position detected by the illumination device position detecting means; and illumination data generating means for generating, in accordance with features of image data, illumination control data for controlling each of the at least one illumination device, the features being extracted in accordance with the information stored by the storing means.

The present invention provides an audio-visual environment control device for controlling, in accordance with features of an image to be displayed by a display device, illumination light from at least one illumination device provided in an audio-visual space in which the display device is provided, the audio-visual environment control device including: illumination device position detecting means for detecting each installation position of the at least one illumination device; and illumination data generating means for (i) extracting features in a partial region of an image, the partial region corresponding to the each installation position detected by the illumination device position detecting means and (ii) generating illumination control data for controlling each of the at least one illumination device in accordance with the features thus extracted.

The present invention provides an audio-visual environment control device for controlling illumination light from at least one illumination device in accordance with (i) reference data, obtained from an external device, on an illumination device position in a virtual audio-visual environment space and (ii) illumination control data, obtained from an external device, corresponding to the illumination position in the virtual audio-visual environment space, the audio-visual environment control device including: illumination device position detecting means for detecting each installation position of the at least one illumination device; storing means for storing information on the each installation position detected by the illumination device position detecting means; and illumination data converting means for converting, in accordance with (i) the information stored in the storing means and (ii) the reference data, the illumination control data into illumination control data for controlling each of the at least one illumination device.

The present invention provides an audio-visual environment control device, including: receiving means for receiving, (i) reference data indicating an arrangement in which at least one illumination device is provided in a virtual space and (ii) illumination control data for controlling illumination light from each of the at least one illumination device having the arrangement indicated by the reference data, so as to cause the reference data and the illumination control data to be correlated with each other; illumination device position detecting means for detecting a position of an illumination device provided in an actual space; and illumination control data converting means for converting the illumination control data received by the receiving means so that an illumination effect, similar to an illumination effect that is obtained in a case where the illumination light from each of the at least one illumination device having the arrangement indicated by the reference data received by the receiving means is controlled, is obtained in a case where the illumination device is provided at the position detected by the illumination device position detecting means.

The present invention provides an audio-visual environment control device for controlling illumination light from at least one illumination device in accordance with illumination control data obtained from an external device, the audio-visual environment control device including: illumination device position detecting means for detecting each installation position of the at least one illumination device; sending means for sending, to the external device, information on the each installation position detected by the illumination device position detecting means; and receiving means for receiving illumination control data generated by the external device in accordance with the information on the each installation position of the at least one illumination device.

The present invention provides an audio-visual environment control method for controlling illumination light from at least one illumination device in accordance with features of image data to be displayed by a display device, the audio-visual environment control method including the steps of: (i) detecting each installation position of the at least one illumination device; (ii) storing information on the each installation position detected in the step (i); and (iii) generating, in accordance with features of image data, illumination control data for controlling each of the at least one illumination device, the features being extracted in accordance with the information on the each installation position, the information being stored in the step (ii).

The present invention provides an audio-visual environment control method for controlling illumination light from at least one illumination device in accordance with (i) reference data, obtained from an external device, on an illumination device position in a virtual audio-visual environment space and (ii) illumination control data, obtained from an external device, corresponding to the illumination position in the virtual audio-visual environment space, the audio-visual environment control method including the steps of: (i) detecting each installation position of the at least one illumination device; storing information on the each installation position detected in the step (i); and (iii) converting, in accordance with (a) the information stored in the step (ii) and (b) the reference data, the illumination control data, into illumination control data for controlling each of the at least one illumination device.

The present invention provides an audio-visual environment control method for controlling illumination light from at least one illumination device in accordance with illumination control data obtained from an external device, the audio-visual environment control method comprising the steps of: (i) detecting each installation position of the at least one illumination device; sending means for sending, to the external device, information on the each installation position detected in the step (i); and (iii) receiving illumination control data generated by the external device in accordance with the information on the each installation position of the at least one illumination device.

The present invention allows automatic detection of the installation position of at least one illumination device in an audio-visual environment space and also allows generation of the most suitable illumination control data corresponding to the above-detected installation position of the illumination device. This allows suitable illumination control, e.g., in the case where the installation position of an illumination device in the audio-visual environment is changed, or in the case where an additional illumination device is provided.

This consequently allows suitable illumination control for any audio-visual environment that varies according to each individual viewer and provides a highly realistic atmosphere.

### BRIEF DESCRIPTION OF DRAWINGS

FIG. 1 is a block diagram illustrating an audio-visual environment control device in accordance with a first embodiment of the present invention.

FIG. 2 is an external view illustrating examples of an illumination device used in the first embodiment of the present invention.

FIG. 3 is an explanatory view illustrating an example of an audio-visual environment space.

FIG. 4 is a functional block diagram illustrating the arrangement of the illumination device position detecting section 6 in FIG. 1.

FIG. 5 is an external view illustrating an optical sensor.

FIG. 6 is a flow diagram illustrating an example of the operation of detecting illumination device positions and generating an illumination device position table in accordance with the first embodiment of the present invention.

FIG. 7 is an explanatory view illustrating data stored in the illumination device position table 8 in FIG. 1.

FIG. 8 is a flow diagram illustrating an example of the operation of the illumination control data generating section 9 in FIG. 1.

FIG. 9 is an explanatory view illustrating illumination devices installed in an audio-visual environment space for a viewer.

FIG. 10 is an explanatory view illustrating an example of a display image.

FIG. 11 is an explanatory view illustrating feature detection regions of the display image in FIG. 10.

FIG. 12 is a block diagram illustrating an audio-visual environment control device in accordance with a second embodiment of the present invention.

FIG. 13 is a view illustrating a virtual audio-visual environment space (audio-visual environment reference data).

FIG. 14 is a view illustrating the virtual audio-visual environment space in FIG. 13 containing illumination devices installed in an actual audio-visual environment space.

FIG. 15 is an explanatory view illustrating a process of converting an area in the actual audio-visual environment space, the process being performed when the method of converting illumination control data in FIG. 14 is used.

FIG. 16 is an explanatory view schematically illustrating another example of a method of converting illumination control data (i.e., a conversion method using the proportions of the respective reciprocals of the distances between an illumination device and four virtual illumination devices).

FIG. 17 is an explanatory view schematically illustrating still another example of a method of converting illumination control data (i.e., a conversion method using the proportions of the respective reciprocals of the distances between an illumination device and eight virtual illumination devices).

FIG. 18 is an explanatory view schematically illustrating yet another example of a method of converting illumination control data (i.e., a conversion method using blocks of space).

FIG. 19 is a block diagram illustrating an audio-visual environment control device in accordance with a third embodiment of the present invention.

### DESCRIPTION OF EMBODIMENTS

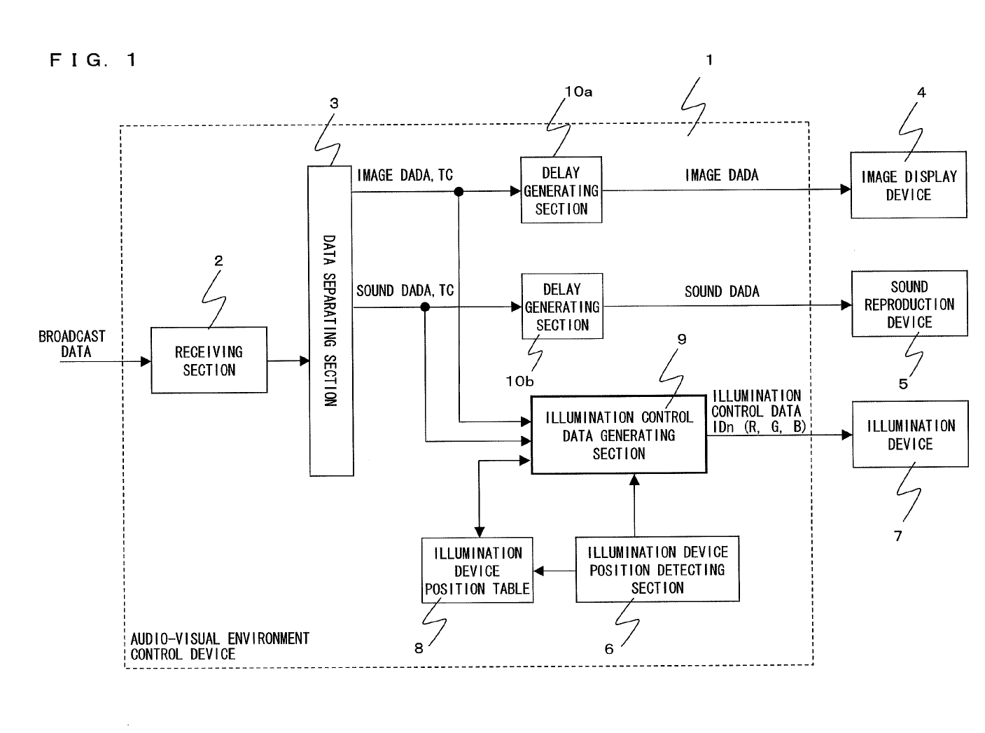

Audio-visual environment control devices and audio-visual environment control systems according to the embodiments of the present invention will be described with reference to FIGS. 1 through 19.

### First Embodiment

FIG. 1 is a block diagram illustrating an audio-visual environment control device according to a first embodiment of the present invention. The audio-visual environment control device 1 of the present embodiment causes a receiving section 2 to receive broadcast data sent from a sender (broadcast station) and also causes a data separating section 3 to separate the broadcast data into image data and sound data, which are multiplexed in the broadcast data. The image data and the sound data obtained as a result of the separation by the data separating section 3 are sent to an image display device 4 and a sound reproduction device 5, respectively.

Subsequently, an illumination device position detecting section (illumination device position detecting means) 6 receives illumination light from at least one illumination device 7 installed in an audio-visual environment space and labeled in advance with an identifier (hereinafter referred to as “ID”), detects the installation position of each illumination device 7 on the basis of the illumination light, and sends data (illumination device position data) on the thus-detected installation position of each illumination device 7 to an illumination device position table 8. The illumination device position table 8 stores the illumination device position data in a table format by ID of each illumination device 7. The illumination device position data stored in the illumination device position table 8 is sent to an illumination control data generating section (illumination data generating means) 9 in accordance with instructions from the illumination control data generating section 9. The illumination control data generating section 9 generates suitable illumination control data corresponding to the installation position of each illumination device 7, from the image data and the sound data obtained as a result of the separation by the data separating section 3 as well as the illumination device position data read from the illumination device position table 8 and corresponding to each illumination device 7. The illumination control data generating section 9 then sends the above-generated illumination control data to each illumination device 7.

The illumination control data to be sent to each illumination device 7 needs to have an output timing synchronous with the respective output timings of the image data and the sound data. In view of this, the audio-visual environment control device 1 includes, for example, delay generating sections 10a and 10b for respectively delaying the image data and the sound data obtained as a result of the separation by the data separating section 3, for a period of time necessary for the illumination control data generating section 9 to generate the illumination control data. This allows the respective output timings of the image data and the sound data to be synchronous with the output timing of the illumination control data.

In other words, the audio-visual environment control device 1 is an audio-visual environment control device that controls, on the basis of the feature of each image displayed by the image display device 4, illumination from at least one illumination device 7 provided in an audio-visual space in which the image display device 4 is provided. The audio-visual environment control device 1 also includes (i) the illumination device position detecting section 6 for detecting the installation position of each illumination device 7 and (ii) the illumination control data generating section 9 for generating illumination control data for controlling each illumination device 7.

The illumination control data refers, specifically, to data for individually controlling the respective illuminations from multiple illumination devices 7, e.g., data (control signal) for controlling, for example, the color and light intensity (luminance) of the illumination from each illumination device 7.

The illumination device position table 8 may also be considered as a storing section (storing means) storing an illumination device position table.

The above arrangement allows the audio-visual environment control device to suitably control at least one illumination device 7 installed in an audio-visual environment space, in accordance with the installation position of each illumination device 7. Further, the above arrangement allows suitable illumination control in any case: e.g., in the case where an illumination device 7 is reinstalled at a different position in the audio-visual environment space; in the case where an additional illumination device 7 is provided; or even in the case where the image display device 4 is moved to a different position. The audio-visual environment control device 1 may be provided integrally with the image display device 4 and the sound reproduction device 5. Alternatively, they may be provided separately.

The following describes in detail the illumination devices 7 and the audio-visual environment control device 1.

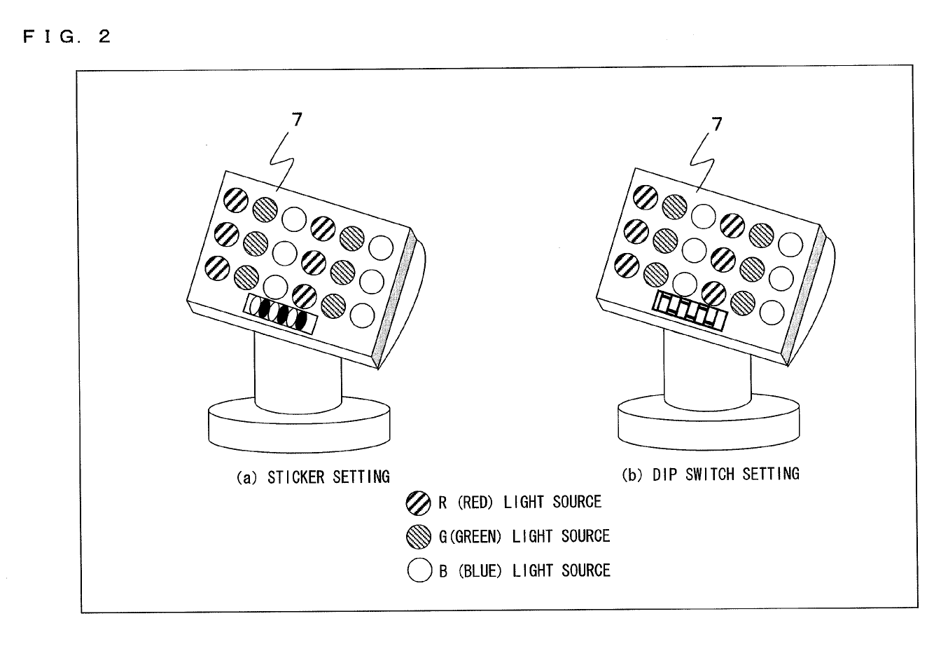

The illumination devices 7 will be described first. FIG. 2 is an external view illustrating an example of the illumination devices 7 used in the present embodiment. As mentioned above, the illumination devices 7 are labeled with their respective unique IDs for individually identifying each of the multiple illumination devices 7. Each of the illumination devices 7 illustrated in FIG. 2 includes, for example, LED light sources of red (R), green (G), and blue (B) disposed at regular intervals and individually controllable for light emission. Each of the illumination devices 7 uses its LED light sources of the three primary colors so as to emit illumination light having a desired color and luminance.

It should be noted that the illumination devices 7 may have any arrangement, provided that the arrangement allows the illumination devices 7 to control the color and brightness of the ambient light around the image display device 4. Each illumination device 7 may include white LEDs and color filters instead of the combination of the LED light sources emitting lights of the above predetermined colors. Alternatively, each illumination device 7 may include, for example, the combination of white lamps or fluorescent tubes and color filters, or color lamps. In addition, the illumination devices 7 are not necessarily illumination devices of a variable color type; alternatively, each illumination device 7 may, for example, include white lamps or fluorescent tubes so that only the luminance of white light is variably controlled for each illumination device 7. This also allows achievement of a highly realistic atmosphere as compared to the case in which the luminance of the illumination light is fixed.

(a) of FIG. 2 is an explanatory view illustrating a method of labeling each illumination device 7 with an ID for its identification, the method involving use of stickers. The illumination device 7 in (a) of FIG. 2 is provided, below its LED light sources, with hole sections to which stickers can be attached. As illustrated in (a) of FIG. 2, the illumination device 7 is provided, as an example, with six hole sections, and a light-blocking sticker can be attached to each of the hole sections. The illumination device includes, inside itself, optical sensors disposed at positions corresponding to the hole sections so that each of the light sensors detects whether or not a sticker is attached to its corresponding hole section, i.e., whether its corresponding hole section is in a light-transmitting state or in a light-blocking state. This allows providing up to 2⁶ (6 bits; 64 patterns) IDs to different illumination devices by means of how stickers are attached to the hole sections. It is clear that the number of the hole sections to which stickers can be attached may be increased, e.g., to seven or eight, when the number of illumination devices 7 installed in an audio-visual environment space is more than 64, so that an unlimited number of illumination devices 7 may be installed.

(b) of FIG. 2 is an explanatory view illustrating a method of labeling each illumination device 7 with an ID for its identification, the method involving use of a DIP switch. The illumination device 7 in (b) of FIG. 2 is provided, below its LED light sources, with a DIP switch. The DIP switch includes turns each capable of being set to conduct or block electric signals, in place of the above stickers that can be attached to the hole sections. As illustrated in (b) of FIG. 2, the DIP switch, as an example, includes six switches. The illumination device 7 detects, for example, the conductive state from a switch having a toggle lever set to the upper position and the non-conducting state from a switch having a toggle lever set to the lower position. This allows providing up to 2⁶ (6 bits; 64 patterns) IDs to different illumination devices. It is clear that the number of the switches may be increased, e.g., to seven or eight, when the number of illumination devices 7 installed in an audio-visual environment space is more than 64, so that an unlimited number of illumination devices 7 may be installed.

The following describes how the respective positions of multiple illumination devices 7 are detected.

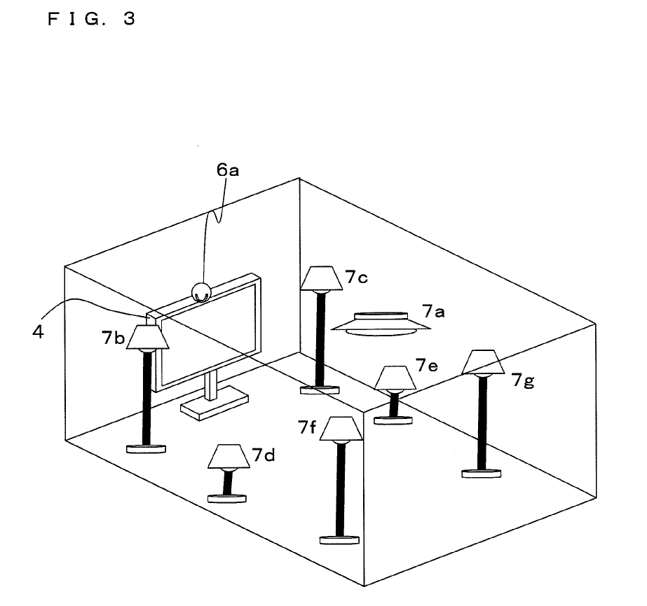

FIG. 3 is an explanatory view illustrating an example of an audio-visual environment space. The audio-visual environment space contains the image display device 4 and seven illumination devices 7 installed therein. The illumination device 7a is the type of illumination device that is installed on the ceiling, whereas each of the illumination devices 7b through 7g is the type of illumination device that is portably installed. The arrangement and number of the illumination devices 7a through 7g vary according to the audio-visual environment space for each viewer. They also vary, even in the same audio-visual environment space, e.g., when the illumination devices 7 are moved, when an additional illumination device 7 is provided, and/or when any of the illumination devices 7 is removed, for room rearrangement, for example. In addition, moving the image display device 4 changes the relative position of each illumination device 7 with respect to the image display device 4.

As described above, the respective installation positions and number of the illumination devices 7 in the audio-visual environment space vary according to each viewer, and they also vary, even for the same viewer, because of room rearrangement, for example. Constantly controlling the illumination devices 7 in a suitable manner for achievement of a highly realistic atmosphere even in the above case requires detecting the position of each illumination device installed in the audio-visual environment space and thereby controlling its illumination in accordance with the position detected.

The following describes a method of individually detecting the respective installation positions of the illumination devices in an audio-visual environment space so that their illuminations are suitably controlled in accordance with the detection result.

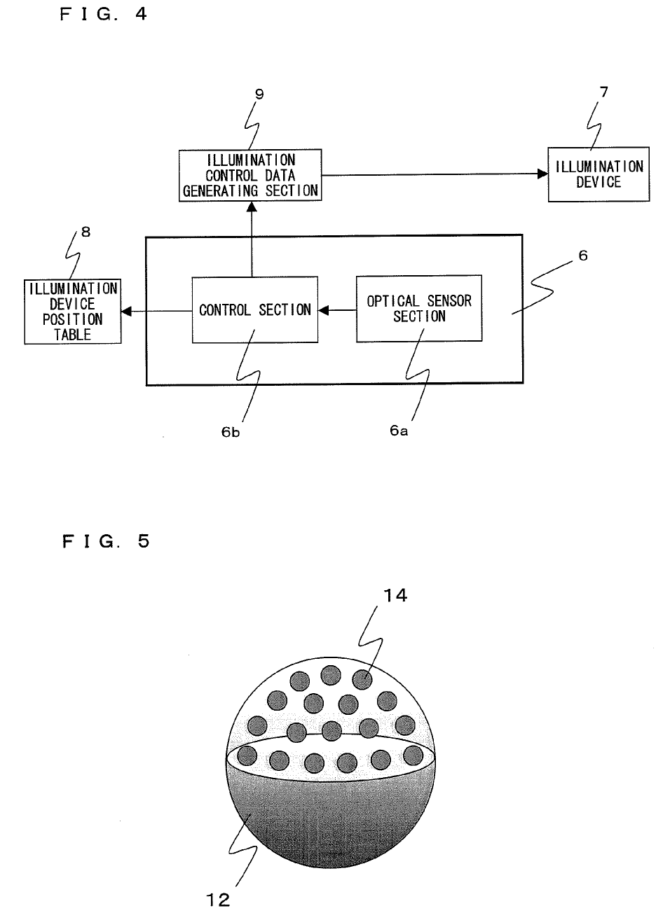

FIG. 4 is a functional block diagram illustrating the arrangement of the illumination device position detecting section 6 in FIG. 1. The illumination device position detecting section 6 includes an optical sensor 6a and a control section 6b. First, the optical sensor 6a is, for example, a photo sensor capable of detecting the direction and intensity of incident light. Specifically, as illustrated in FIG. 5, the optical sensor 6a includes multiple light-receiving elements 14 disposed in half of the region of the spherical surface, so that the optical sensor 6a has a mechanism for receiving light incident in many directions. The optical sensor 6a is preferably provided on the image display device 4 as illustrated in FIG. 3. This is because suitably controlling the illumination from each illumination device in an audio-visual environment space requires data on the relative positional relationship between the image display device 4 and each illumination device 7.

Even when, for example, the image display device 4 is moved and thereby the relative positional relationship between the image display device 4 and each illumination device 7 is changed, the disposition of the optical sensor 6a on the image display device 4 eliminates the need to detect the position of the image display device 4 with use of the optical sensor 6a. The optical sensor 6a only needs to detect the position of each illumination device 7 so as to detect the relative position of each illumination device 7 with respect to the image display device 4.

The control section 6b detects the installation position of each illumination device 7 on the basis of the intensity and direction of light detected by the optical sensor 6a. Specifically, the control section 6b estimates the distance between the optical sensor 6a and a specific illumination device 7 on the basis of the largest quantity of light among the respective quantities of light detected by the multiple light-receiving elements 14 and also estimates that the specific illumination device 7 is present in the direction faced by a specific one of the light-receiving elements 14 that has detected the largest quantity of light, whereby the control section 6b determines the relative position of the specific illumination device 7 with respect to the optical sensor 6a. In the present embodiment, the control section 6b determines the installation position of each illumination device 7 in the form of a vector with the position of the optical sensor 6a being the origin and sends the thus-determined vector data to the illumination device position table 8.

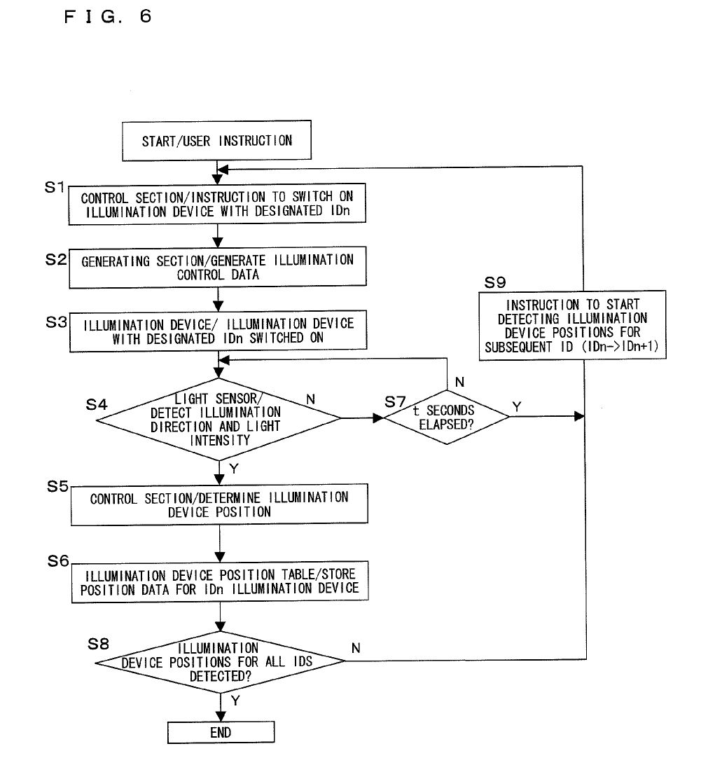

FIG. 6 is a view illustrating a flow of the operation of detecting illumination device positions and generating an illumination device position table in connection with FIG. 1. First, when a viewer gives a command with use of, for example, a remote (remote control) to start the operation of automatically detecting the position of each illumination device 7, the control section 6b, in response to the command, sends a command to the illumination control data generating section 9 to turn only on IDn illumination device (n=1 during the initial operation) and to turn off the other illumination devices (Step 1). In response to the command from the control section 6b, the illumination control data generating section 9 supplies to the illumination devices illumination control data (e.g., in the case of performing drive control of the respective tones of the LED light sources of R, G, and B each in units of 8 bits and n being 1, ID1 (255, 255, 255), ID2 (0, 0, 0), ID3 (0, 0, 0), . . . , IDn (0, 0, 0)) according to the command (Step 2). Successively supplying such illumination control data turns on each designated IDn illumination device at the highest luminance and turns off the other illumination devices (Step 3).

While the above is in process, the optical sensor 6a determines whether it receives illumination light from each designated IDn illumination device (Step 4). When the optical sensor 6a receives illumination light from a specific IDn illumination device, the control section 6b determines the installation position of the specific IDn illumination device on the basis of the intensity and direction of the illumination light received by the optical sensor 6a (Step 5). The control section 6b writes the thus-determined illumination device position data to an address in the illumination device position table 8, the address corresponding to the specific IDn illumination device (Step 6). When the optical sensor 6a receives no illumination light from a specific IDn illumination device in Step 4, the control section 6b determines whether or not such a state has continued for a predetermined period of t seconds (Step 7). The optical sensor 6a repeats the operation of detecting illumination light according to Step 4 until t seconds elapse.

Subsequently, it is determined whether or not the respective positions of the illumination devices of all IDs have been detected (Step 8). When it is determined that the respective positions of the illumination devices of all IDs have been detected, the operation is ended. When it is determined that the respective positions of the illumination devices of not all IDs have been detected in Step 8, one is added to the value of n and then the control section 6b supplies a command so that the installation position of the subsequent IDn+1 illumination device is detected (Step 9).

For example, when the position of ID1 illumination device has been detected and that of ID2 illumination device is next to be detected, the control section 6b sends a command to the illumination control data generating section 9 to turn only on ID2 illumination device and to turn off the other illumination devices. Through the same steps as the above, the control section 6b determines illumination device position data for ID2 illumination device and writes the thus-determined illumination device position data to an address in the illumination device position table 8, the address corresponding to ID2 illumination device.

When it is detected that the optical sensor 6a receives no illumination light from a specific IDn illumination device for t seconds in Step 7, it is determined that the specific IDn illumination device does not exist in the audio-visual environment space. Then, one is added to the value of n, and the control section 6b supplies a command so that the installation position of the subsequent IDn+1 illumination device is detected (Step 9). Performing the above-described series of steps as many times as the number of illumination devices installed results in the respective installation positions of all the illumination devices being stored in the illumination device position table 8 in association with their corresponding IDs.

As discussed above, the illumination control data, in the present embodiment, includes a 6-bit ID followed by three sets of 8-bit control data for controlling the illumination device having the ID, the three sets corresponding to red (R), green (G), and blue (B), respectively. Each illumination device compares the ID given to itself with the ID included in the illumination control data so as to obtain control data added to the ID of its own. This allows each illumination device to emit its desired illumination light.

The above-described operation of detecting illumination device positions starts with storing the intensity and direction of light that is detected by the optical sensor 6a while all the illumination devices 7 are off, the intensity with regard to the direction being later subtracted from a detection result obtained in Step 4. This eliminates the influence of external light other than the illumination light from the illumination devices 7, thereby allowing a more precise operation of detecting illumination device positions.

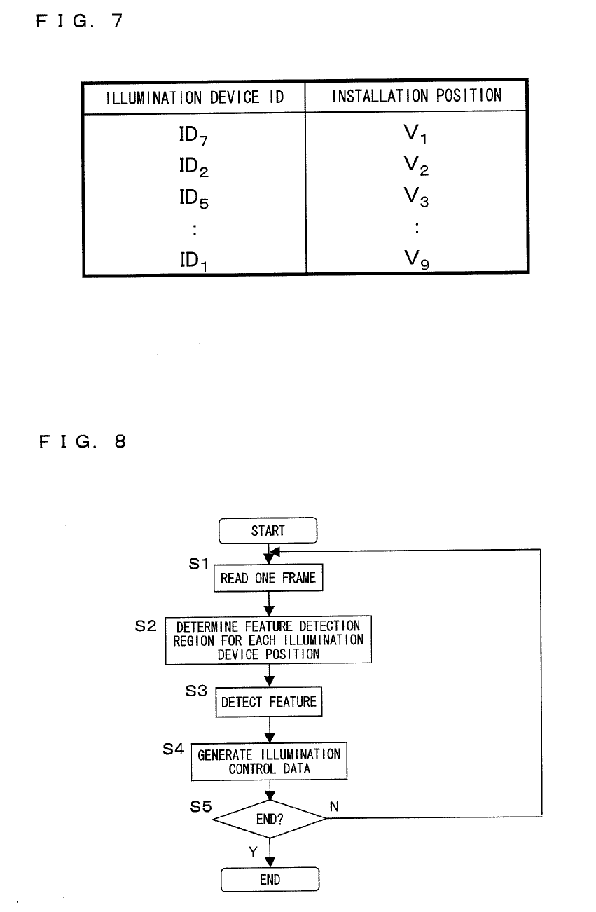

The illumination device position table 8 stores, in a table format as illustrated in FIG. 7, illumination device position data sent from the control section 6b. Specifically, the illumination device position table 8 includes sections to store illumination device position data for individual IDs (for example, ID1=“000001” in the case of 6-bit identification data) given by means of the sticker setting or the DIP switch setting described above, and stores as vector data the respective installation positions of the illumination devices in an ID-to-ID correspondence in the sections for illumination device position data. It is clear that any data indicating the respective installation positions of the illumination devices may be stored in the sections for illumination device position data; for example, such data may be in the form of space coordinates in a three-dimensional space or any other form of illumination device position data.

The following describes how suitable illumination control data is generated from illumination device position data obtained as a result of detection according to the above-described method of detecting the positions of illumination devices.

FIG. 8 is a view illustrating a flow of the operation by the illumination control data generating section 9. First, the illumination control data generating section 9 reads, in units of one frame, the image data obtained as a result of the separation by the data separating section 3 in FIG. 1 (Step 1). The illumination control data generating section 9 refers to data on the position of each illumination device, stored in the illumination device position table 8, so as to determine, for each illumination device, a screen region in which the image feature is to be detected (Step 2). The illumination control data generating section 9 then detects the feature in the above-determined screen region for the image data for one frame read in Step 1 (Step 3).

The feature of the image data may be determined using, for example, color signals or luminance signals, as well as ambient color temperatures obtained at the time of shooting the image. In the present embodiment, the illumination control data generating section 9 detects not only the feature of the image data, but also that of the sound data. The feature of the sound data may be determined using, for example, volumes or audio frequencies.

Subsequently, the illumination control data generating section 9 generates illumination control data for each illumination device, from the image feature and/or the sound feature detected as above (Step 4). For example, the illumination control data generating section 9 may determine the average of the image features in the screen regions corresponding to the respective installation positions of the illumination devices, the installation positions being detected by the illumination device position detecting section 6, so as to generate illumination control data from the above-determined average. The method of generating illumination control data is clearly not limited to obtaining the average of the image features and therefore may be any other determination method.

In other words, the illumination control data generating section 9 determines partial regions of an image displayed by the image display device 4, the partial regions corresponding to the installation positions of the illumination devices 7, the installation positions being detected by the illumination device position detecting section 6, so as to extract the respective image features in the thus-determined partial regions. The illumination control data generating section 9 then performs a predetermined operation on the thus-extracted features so as to generate illumination control data corresponding to the values obtained through the operation, as illumination control data for controlling each illumination device 7.

Subsequently, the illumination control data generated by the illumination control data generating section 9 and the image data and the sound data for the frame corresponding to the illumination control data are sent, in synchronization with each other, to each illumination device 7, the image display device 4, and the sound reproduction device 5, respectively. On completion of generation of illumination control data for one frame, the illumination control data generating section 9 determines whether or not a subsequent frame is to be supplied, i.e., whether or not the supplying of image data has ended (Step 5). When a subsequent frame is to be supplied, the illumination control data generating section 9 reads this subsequent frame (Step 1). When no subsequent frame is to be supplied, the processing operation is ended. Sequentially repeating the above steps allows performance of illumination control suitable for the display image for each image frame.

The following describes a manner of determining a target region for detection of the feature according to Step 2.

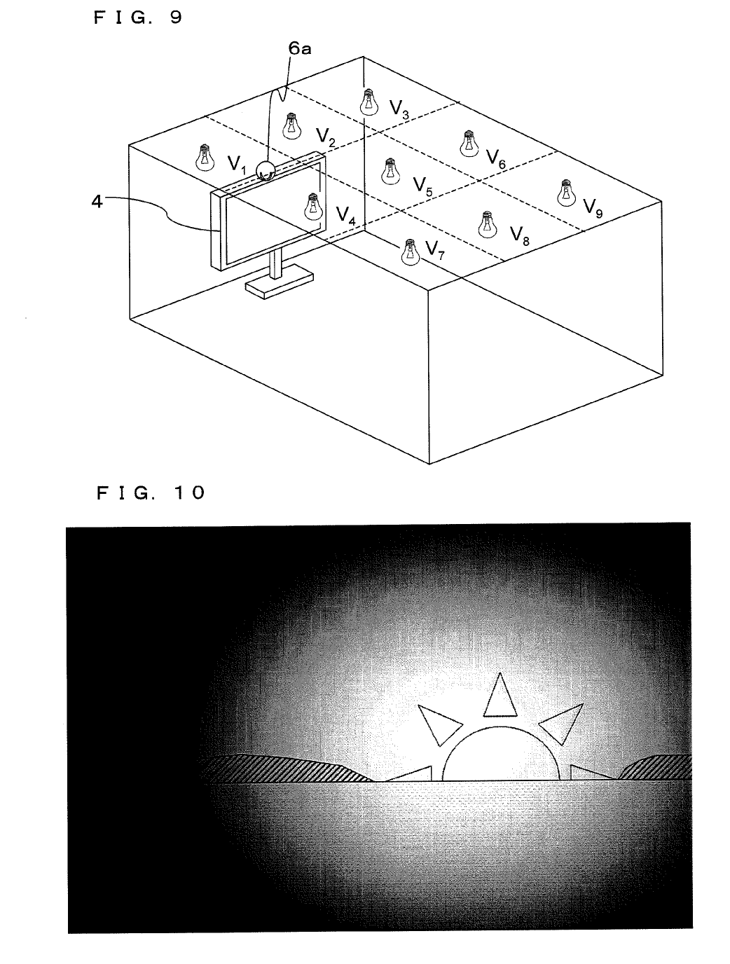

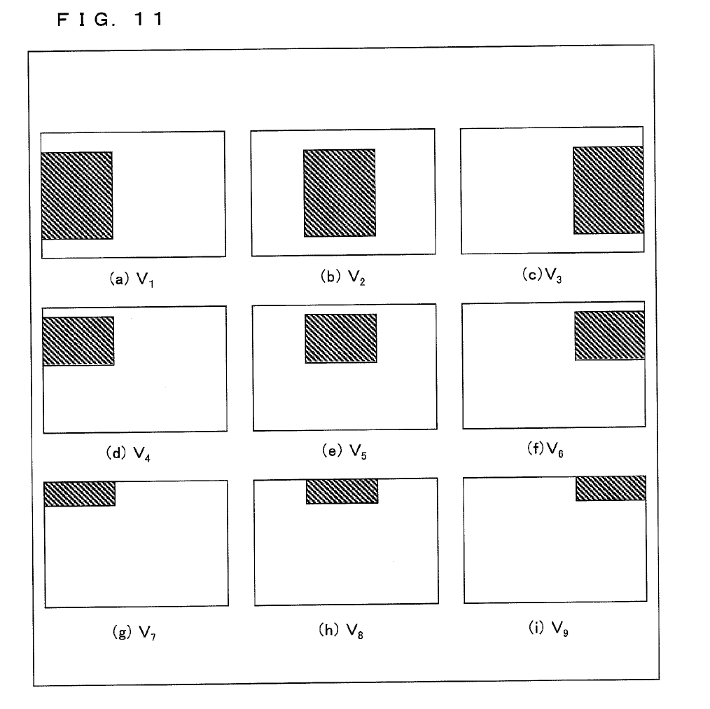

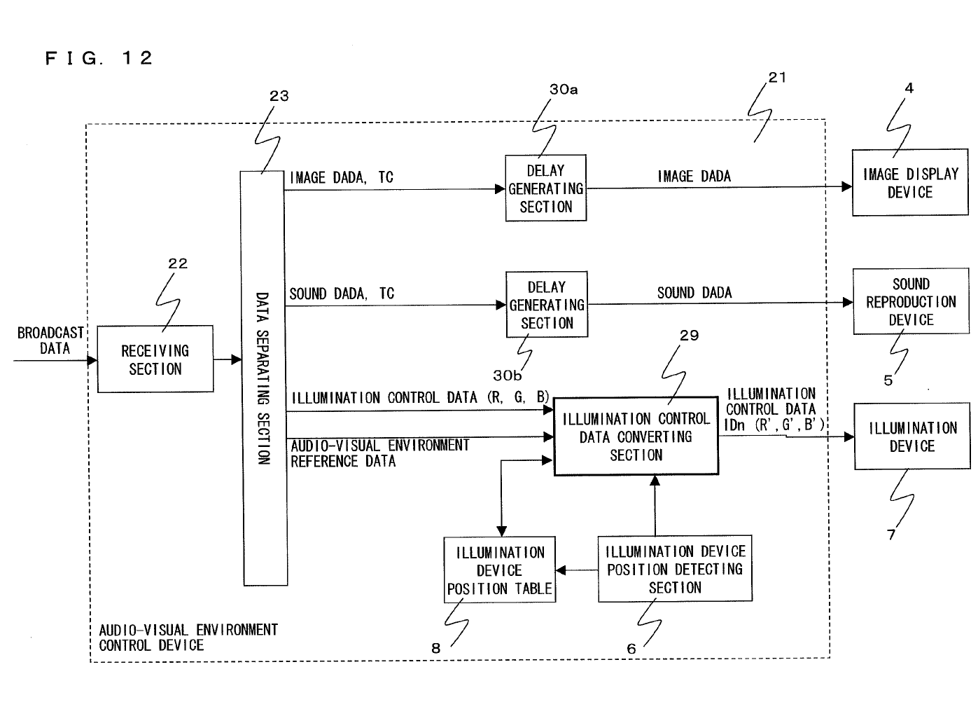

It is assumed that, for example, nine illumination devices are provided on the ceiling in the audio-visual environment space for a viewer as illustrated in FIG. 9 and that the image data (one frame) read represents an image of a setting sun as illustrated in FIG. 10. The image data of FIG. 10 is bright in the region corresponding to the image of the sun and becomes gradually darker as farther away from the image of the sun toward its surrounding region. This makes it preferable to detect the image features in the feature detection regions illustrated in FIG. 11, the regions corresponding to the respective positions of the illumination devices.

Specifically, assuming that the horizontal and vertical directions parallel to the screen of the image display device 4 are designated as the x and y directions, respectively, the determination of feature detection regions starts with determination of such regions with respect to the x direction, followed by determination of them with respect to the y direction. The feature detection regions for the illumination devices are finally determined based on the respective feature detection regions determined with respect to the x direction and the y direction.

The illumination devices installed in the audio-visual environment space illustrated in FIG. 9 can be grouped, for each set of illumination devices having an identical position with respect to the x direction, into three columns: the illumination devices v1, v4, and v7 positioned to the left of a viewer facing the screen; the illumination devices v2, v5, and v8 positioned in the middle; and the illumination devices v3, v6, and v9 positioned to the right of a viewer facing the screen (hereinafter referred to as “left illumination device column”, “middle illumination device column”, and “right illumination device column”, respectively). The left illumination device column has its feature detection regions in the left screen portion of the image data. The middle illumination device column has its feature detection regions in the middle screen portion of the image data. The right illumination device column has its feature detection regions in the right screen portion of the image data. In other words, the columnar position of each illumination device determines its feature detection region with respect to the x direction of the display screen of the image display device 4.

Next, the illumination control data generating section 9 determines the feature detection regions with respect to the y direction of the display screen of the image display device 4. The feature detection regions with respect to the y direction need to be suitably determined based on such data as the content (e.g., luminance distribution, color distribution, histogram) or category of an image displayed by the image display device 4, or on the combination of them. The feature detection regions may be determined based on an indicator selected from a large number of indicators, among which the most suitable one is used according to need. In the present embodiment, the feature detection regions of the image illustrated in FIG. 10 are determined using the content (i.e., luminance distribution) of the display image as an indicator for the determination of the feature detection regions.

FIG. 10 illustrates an image of the sun setting in the sea. The image of the sun displayed at the central portion of the image screen has the highest luminance. The luminance of the image on the screen becomes continuously lower as farther away from the image of the sun toward its surrounding region.

The illumination devices installed in the audio-visual environment space illustrated in FIG. 9 can be grouped, for each set of illumination devices having an identical position with respect to the y direction, into three rows: the illumination devices v1, v2, and v3 positioned closest to the screen; the illumination devices v4, v5, and v6 positioned so as to face the screen across the illumination devices v1, v2, and v3; and the illumination devices v7, v8, and v9 positioned farthest from the screen (hereinafter referred to as “closest illumination device row”, “middle illumination device row”, and “farthest illumination device row”, respectively). The closest illumination device row is installed closest to the image display device 4, which indicates that it is positioned farthest in the direction of the image display device 4 from a viewer.

The above requires the closest illumination device row to produce illumination light on the basis of the color and brightness of a portion of the display image, the portion displaying a spot far from the shooting spot. In the case of the image in FIG. 10, the closest illumination device row needs to have its feature detection regions in a portion of the display image, the portion corresponding to the horizon. However, producing illumination light with the closest illumination device row in accordance only with the image feature in the portion corresponding to the horizon would cause the illumination light to have too high a luminance and thereby cause the display image in the portion corresponding to the horizon to lose continuity with the display image in an upper portion of the screen. This would result in an inharmonious display image. Thus, as illustrated in (a) through (c) in FIG. 11, the illumination devices v1, v2, and v3 are set to have their respective feature detection regions collectively including the horizon in their central portions as well as a large portion adjacent to the horizon.

The farthest illumination device row is positioned farthest from the image display device 4 and is a row of illumination devices positioned, for example, directly above a viewer. The farthest illumination device row needs to produce illumination light on the basis of the color and brightness of a portion of the display image, the portion displaying a spot closest to the shooting spot. In the case of the image in FIG. 10, the closest illumination device row needs to have its feature detection regions in a portion of the display image, the portion being the uppermost portion of the image of the sky. Further, the farthest illumination device row needs to reproduce the space of the shooting spot. Thus, as illustrated in (g) through (i) in FIG. 11, the illumination devices v7, v8, and v9 are set to have small feature detection regions so as to reproduce the color and brightness of the sky directly above the shooting spot. This effectively allows improvement in the realistic atmosphere.

The middle illumination device row may play a role intermediate between the closest illumination device row and the farthest illumination device row described above. Specifically, in the case of the image in FIG. 10, the middle illumination device row needs to have its feature detection regions in a portion of the display image, the portion being a portion of the sky, positioned between the horizon and the portion of the sky directly above the shooting spot. Thus, as illustrated in (d) through (f) in FIG. 11, the illumination devices v4, v5, and v6 may be set to have their respective feature detection regions between those of the closest illumination device row and those of the farthest illumination device row.

Setting image feature detection regions in accordance with the respective installation positions of the illumination devices as described above allows, when the image in FIG. 10 is displayed, effective control of the illumination light from each illumination device installed around the image display device 4 and thereby provides a viewer with a highly realistic atmosphere. The method of determining image feature detection regions is not necessarily limited to the one described above. The determination method may vary, for example, according to the category of the image.

The above embodiment describes detecting the image feature and/or the sound feature for each frame, for generation of illumination control data. Alternatively, the illumination control data generating section 9 may perform its control such that the image feature and/or the sound feature are/is detected for each scene or shot so that the illumination light from each illumination device 7 is substantially maintained for a particular scene or shot in the story.

### Second Embodiment

In addition, the above embodiment describes generating illumination control data for each illumination device on the basis of the feature and/or sound data of image data received by the image receiving device. However, the method used in the present invention is not limited to this.

For example, the following two types of data may be sent from an external device: illumination device position data (audio-visual environment reference data) representing the installation position of each illumination device in a certain virtual audio-visual environment space; and illumination control data for each illumination device in such a virtual audio-visual environment space, both of which are, for example, multiplexed in broadcast waves solely or in combination with image data. In this case, a predetermined conversion process may be provided to the received illumination control data on the basis of (i) the received audio-visual environment reference data and (ii) illumination device position data stored in the illumination device position table. This allows generation of illumination control data for each illumination device installed in the audio-visual environment space for a viewer. This is described below as the second embodiment of the present invention. It should be noted that identical members between the first and second embodiments are represented by the same reference numerals and that the description of such members is omitted.

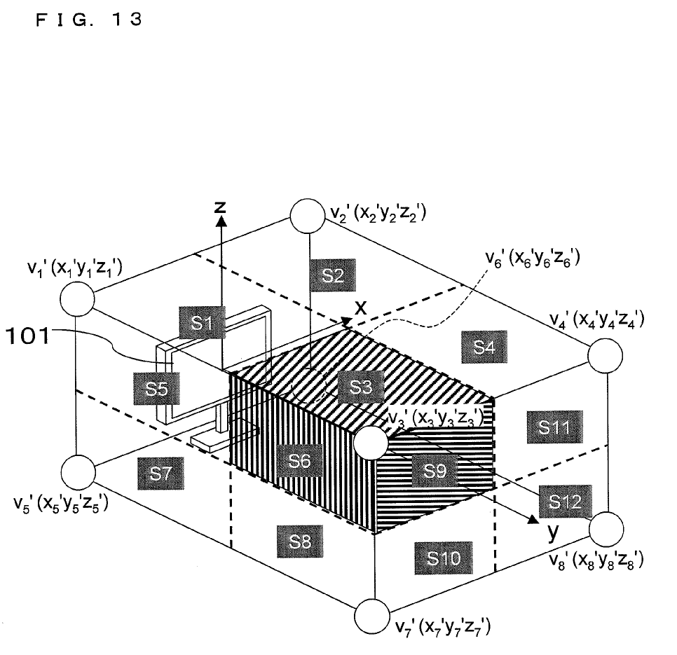

FIG. 12 is a block diagram illustrating an audio-visual environment control device according to the second embodiment of the present invention. The audio-visual environment control device (illumination control device) 21 of the present embodiment causes a receiving section 22 to receive broadcast data sent from a sender (broadcast station) and also causes a data separating section 23 to separate the broadcast data into image data, sound data, illumination control data, and audio-visual environment reference data, which are all multiplexed in the broadcast data. The image data and the sound data obtained as a result of the separation by the data separating section 23 are sent to an image display device 4 and a sound reproduction device 5, respectively. The illumination control data and the audio-visual environment reference data are sent to an illumination control data converting section (illumination data converting means) 29.

The audio-visual environment reference data refers to data indicating the installation position of at least one illumination device provided in a predetermined virtual space (e.g., an audio-visual environment space in which an image display device is provided).

The illumination control data refers to data for individually controlling the illumination from each illumination device provided in the virtual space, e.g., data for controlling, for example, the color and light intensity (luminance) of the illumination from each illumination device. The illumination control data includes data for specifying each target illumination device (e.g., the ID of each illumination device) and control values for controlling the illumination from each illumination device.

The audio-visual environment reference data and the illumination control data are associated with each other: the illumination control data indicates the control values for controlling the illuminations from the illumination devices installed at positions indicated by the audio-visual environment reference data.

Subsequently, an illumination device position detecting section 6 receives illumination light from at least one illumination device 7 installed in an audio-visual environment space and labeled in advance with an identifier (hereinafter referred to as “ID”), detects the installation position of each illumination device 7 on the basis of the illumination light, and sends data (illumination device position data) on the thus-detected installation position of each illumination device 7 to an illumination device position table 8. The illumination device position table 8 stores the illumination device position data in a table format by ID of each illumination device 7. The illumination device position data stored in the illumination device position table 8 is sent to an illumination control data converting section 29 in accordance with instructions from the illumination control data converting section 29. On the basis of (i) the audio-visual environment reference data obtained as a result of the separation by the data separating section 23 and (ii) the illumination device position data read from the illumination device position table 8 and corresponding to each illumination device 7, the illumination control data converting section 29 converts the illumination control data obtained as a result of the separation by the data separating section 23 into suitable illumination control data corresponding to the position of each illumination device 7 installed in the audio-visual environment space. The illumination control data converting section 29 then sends to each illumination device 7 the illumination control data obtained through the above conversion.

The illumination control data (post-conversion illumination control data) to be sent to each illumination device 7 needs to have an output timing synchronous with the respective output timings of the image data and the sound data. In view of this, the audio-visual environment control device 21 includes, for example, delay generating sections 30a and 30b for respectively delaying the image data and the sound data obtained as a result of the separation by the data separating section 23, for a period of time necessary for the illumination control data converting section 29 to generate the illumination control data. This allows the respective output timings of the image data and the sound data to be synchronous with the output timing of the illumination control data.

The operation by the illumination device position detecting section 6 is the same as that in the first embodiment described above. The description of the operation is therefore omitted here. The illumination control data converting section 29 performs an interpolation operation on the illumination control data and the audio-visual environment reference data, both obtained from an external device, so as to determine illumination control data (post-conversion illumination control data) for controlling the brightness and color of the illumination light to be emitted by each illumination device in the actual audio-visual environment space.

In other words, the illumination control data converting section 29 refers to the illumination device position table so as to obtain the illumination device position data indicating the position of each illumination device 7 provided in the actual audio-visual environment space. The illumination control data converting section 29 then converts the illumination control data received by the receiving section 22 into illumination control data (i.e., the illumination control data converting section 29 generates such illumination control data) so that the illumination devices 7 having their respective actual positions (i.e., the respective positions of the illumination devices 7, detected by the illumination device position detecting section 6) produce an illumination effect similar to the illumination effect that would be obtained in the case of controlling the illuminations from the illumination devices provided at the positions indicated by the audio-visual environment reference data received by the receiving section 22.

Subsequently, the illumination control data converting section 29 controls the illumination devices 7 with use of post-conversion illumination control data corresponding to each illumination device 7 (more specifically, by sending the post-conversion illumination control data to each corresponding illumination device 7). The audio-visual environment control device 21 thus has the function as an illumination control device for controlling the illumination devices provided in the actual audio-visual environment space.

Arranging the audio-visual environment control device as described above eliminates the need to provide the function of generating illumination control data from the image feature and/or the sound feature, and also allows suitably controlling at least one illumination device 7 installed in an audio-visual environment space, in accordance with the installation position of each illumination device 7. Further, the above arrangement allows suitable illumination control in any case; e.g., in the case where an illumination device 7 is reinstalled at a different position in the audio-visual environment space or in the case where an additional illumination device 7 is provided.

The following describes three methods of converting illumination control data by the illumination control data converting section 29.

The first method is summarized as follows: when the respective coordinate systems of (i) the virtual audio-visual environment space indicated by the audio-visual environment reference data and (ii) the actual audio-visual environment space for a viewer are, for example, superposed to form a three-dimensional coordinate system with its origin being the center of the screen of the display device, illumination control data is generated on the basis of a region of the walls of the virtual audio-visual environment space, the region being a region onto which light from each illumination device installed in the actual audio-visual environment space is projected.

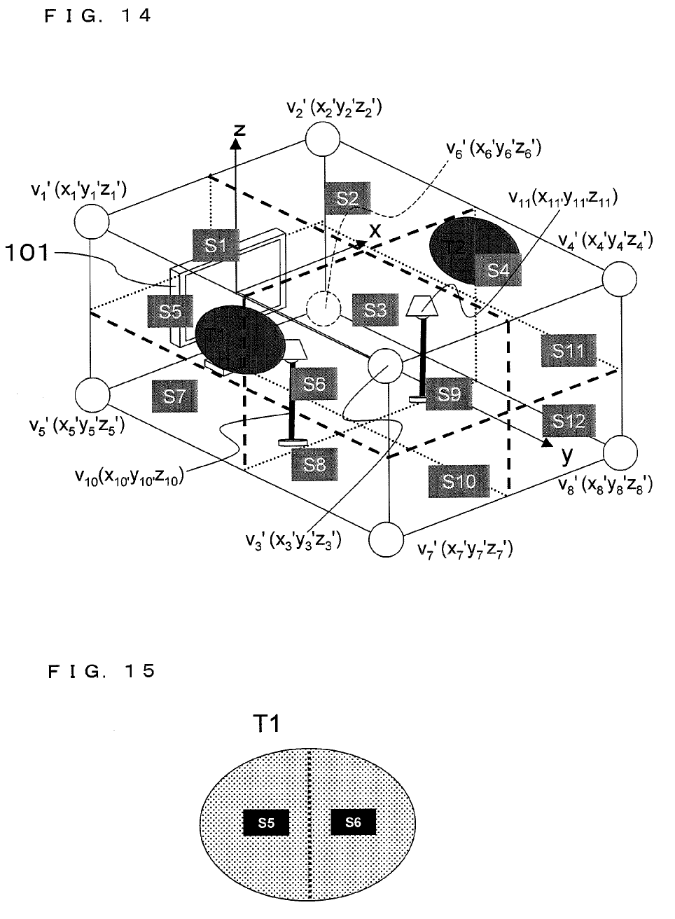

FIG. 13 is a view illustrating a virtual audio-visual environment space (audio-visual environment reference data), which contains illumination devices v1′ through v8′ provided in the eight corners, respectively. The respective three-dimensional positions of the illumination devices v1 through v8 are desirably defined by coordinates of the x axis, the y axis, and the z axis in a three-dimensional coordinate space with the center of the screen of an image display device 101 being the origin (0, 0, 0). In addition, the y axis is desirably defined as coincident with a normal line of the screen of the image display device 101.

Further, the ceiling, the floor, and the four walls of the audio-visual environment space illustrated in FIG. 13 are each segmented into four regions, forming regions Si through S24 (regions S13 through S24 are not shown). Each divisional region is assigned illumination control data for its closest illumination device. For example, the three regions (S3, S6, S9) adjacent to the illumination device v3 in FIG. 13 are assigned the illumination control data for the illumination device v3.

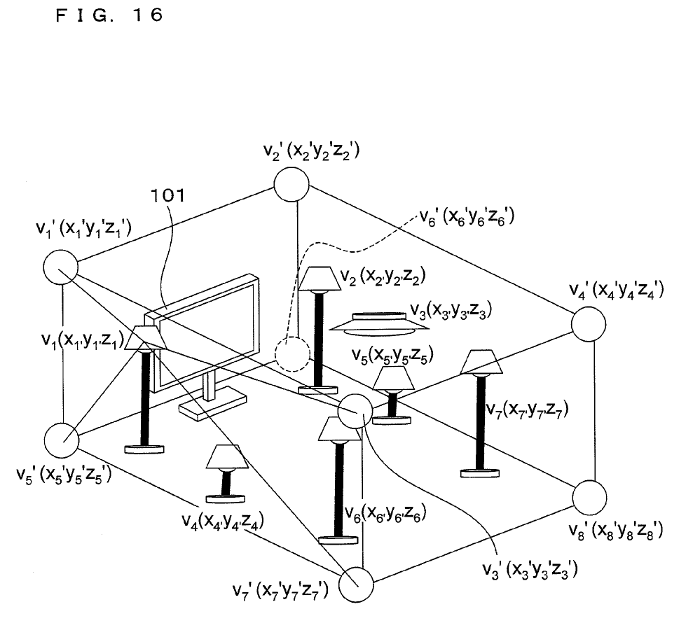

Subsequently, the illumination devices installed in the actual audio-visual environment space are positioned in the above virtual audio-visual environment space so that illumination control data for each illumination device in the actual audio-visual environment space is generated on the basis of illumination control data for the virtual audio-visual environment space. FIG. 14 is a view illustrating the virtual audio-visual environment space, in which illumination devices (v10, v11) installed in the actual audio-visual environment space are positioned. The regions T1 and T2 in FIG. 14 are regions of the walls, the regions being irradiated by the illumination devices (v10, v11), respectively.

The area (and the shape) of each of the irradiation regions T1 and T2 may be determined by the audio-visual environment control device 21 on the basis of data entered by a user so that the area thus determined is stored in a storing section (not shown) available to the illumination control data converting section 9. For example, the area of each of the irradiation regions T1 and T2 may be determinable by: placing each illumination device 7 for actual use at a position a certain distance away from the wall; turning on each illumination device 7 with a certain light intensity; and actually measuring a region of the wall, the region being irradiated by each illumination device 7. Alternatively, the area of each of the irradiation regions T1 and T2 may be determined as follows: A user enters the specifications and the irradiation direction of each illumination device 7 into the audio-visual environment control device 21. Then, the audio-visual environment control device 21 performs a predetermined operation on the basis of the entered data so as to determine the area of each of the irradiation regions T1 and T2. The area of each of the irradiation regions T1 and T2 may be determined at a timing not particularly limited, provided that it is determined before broadcast data is received.

The illumination control data converting section 9 determines which regions (among the regions Si through S24) in the virtual audio-visual environment space correspond to each of the irradiation regions T1 and T2. The illumination control data converting section 9 then controls each of the illumination devices (v10, v11) installed in the actual audio-visual environment space, with use of the control values respectively assigned to the above-determined regions, the control values given to the corresponding illumination devices installed in the virtual audio-visual environment space.

FIG. 15 illustrates an example of a region in the virtual audio-visual environment space, the region corresponding to the irradiation region T1. In FIG. 15, the irradiation region T1 is made up of respective portions of S5 and S6 (S5:S6=1:1). In this case, the illumination device v10 installed in the actual audio-visual environment space is weighted according to the area ratio between the portion of the region S5 and the portion of the region S6, the portions making up the irradiation region T1. Since the area ratio is expressed as S5:S6=1:1 in the case of FIG. 15, the weights are set to 0.5×S5+0.5×S6.

The illumination control data converting section 29 performs an operation based on the illumination control data (R, G, B) for each of the illumination devices v1′ (provided with the illumination value for the region S5) and v3′ (provided with the illumination value for the region S6) in accordance with the above-set weights so as to determine illumination control data (R, G, B) for the illumination device v10.

The illumination control data converting section 29 performs the above operation also with respect to the other illumination device v11 in the actual audio-visual environment space. This results in generation of illumination control data for all the illumination devices installed in the actual audio-visual environment space.

Further, when illumination control data externally obtained is attached to each frame of image data, the illumination control data conversion process is repeatedly performed for each frame. This allows generation of suitable illumination control data according to images displayed on the image display screen.

In addition, according to the above conversion method, illumination control data is converted on the basis of an irradiation region of the wall in the virtual audio-visual environment space. This allows suitable illumination control even when an illumination device installed in the actual audio-visual environment space produces indirect lighting.

As discussed above, according to the above conversion method, the illumination control data converting section 29, with use of audio-visual environment reference data and illumination control data corresponding to the audio-visual environment reference data, both received by the receiving section 22, assigns the illumination control data to each of the divisional regions formed by division, into multiple regions, of each wall three-dimensionally surrounding the virtual audio-visual environment space. For example, the illumination control data converting section 29 determines that illumination control data for the illumination device closest to a certain divisional region is the illumination control data for such a divisional region.

The illumination control data converting section 29 then obtains irradiation region data indicating the area (and the shape) of the region irradiated by the illumination device (e.g., T1) and the above-described illumination device position data. The illumination control data converting section 29 thereby determines the area ratio between the divisional regions that are included in the irradiation region when the region indicated by the irradiation region data and irradiated from the position indicated by the illumination device position data is superposed upon the divisional regions. Further, the illumination control data converting section 9 performs a weighting operation of the illumination control data for each divisional region with use of the above-determined area ratio. This allows determination of illumination control data for the illumination device 7 causing the irradiation region, on the basis of the above-weighted illumination control data for each divisional region.

The illumination control data converting section 9 determines the light intensity in the above irradiation region by, for example, totaling up the respective light intensities in the divisional regions, the light intensities being weighted based on the area ratio between the respective portions of the divisional regions, included in the irradiation region.

The second conversion method is summarized as follows: when the respective coordinate systems of (i) the virtual audio-visual environment space indicated by the audio-visual environment reference data and (ii) the actual audio-visual environment space for a viewer are, for example, superposed to form a three-dimensional coordinate system with its origin being the center of the screen of the display device, illumination control data for controlling each illumination device installed in the actual audio-visual environment space is generated on the basis of the positional relationship between each illumination device installed in the actual audio-visual environment space and the illumination devices installed in the virtual audio-visual environment space.

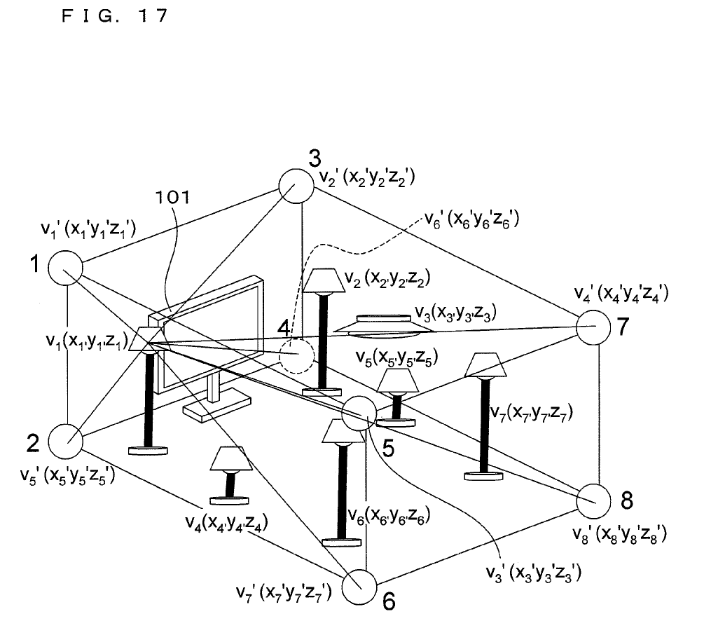

FIG. 16 is a view illustrating a space model similar to the virtual audio-visual environment space model (containing the eight illumination devices v1′ through v8′ provided in the eight corners, respectively) used in the above first conversion method. The view of FIG. 16 illustrates how illumination devices v1 through v7 installed in the actual audio-visual environment space are positioned. The respective three-dimensional positions of the illumination devices are desirably defined by coordinates of the x axis, the y axis, and the z axis in a three-dimensional coordinate space with the center of the screen of an image display device 101 being the origin (0, 0, 0). In addition, the y axis is desirably defined as coincident with a normal line of the screen of the image display device 101.

Illumination control data for controlling the illumination device v1 (x1, y1, z1) in FIG. 16 installed in the actual audio-visual environment space is determined based on the illumination control data for each of the illumination devices v1′, v3′, v5′, and v7′ installed at the four corners of the wall of the virtual audio-visual environment space, the wall being positioned closest to the illumination device v1.

Specifically, the distance between the illumination device v1 and each of the illumination devices v1′, v3′, v5′, and v7′ is determined so that the proportions of the respective reciprocals of the distances are obtained. The illumination devices v1', v3′, v5′, and v7′ are weighted with respect to the illumination device v1 in accordance with the proportions of the reciprocals. The illumination control data converting section 29 performs an operation based on the illumination control data (R, G, B) for each of the illumination devices v1′, v3′, v5′, and v7′ in accordance with the above-set weights so as to determine illumination control data (R, G, B) for the illumination device v1. The illumination control data converting section 29 performs the above operation also with respect to the other illumination devices v2, v3, v4, v5, v6, v7, and v8 in the actual audio-visual environment space. This results in generation of illumination control data for all the illumination devices installed in the actual audio-visual environment space.

More specifically, the illumination control data converting section 29 determines, in a space formed by superposing (i) the coordinate system indicated by illumination device position data stored in the illumination device position table 8 upon (ii) the coordinate system indicated by audio-visual environment reference data, the distance between one of the illumination devices (i.e., first illumination device) indicated by the illumination device position data and each of multiple illumination devices (i.e., second illumination devices) indicated by the audio-visual environment reference data, the multiple illumination devices being positioned in the vicinity of the first illumination device (or having a predetermined positional relationship to the first illumination device). The illumination control data converting section 29 then performs a weighting operation on the values of the illumination control data corresponding to each second illumination device with use of the above-determined distances. The illumination control data converting section 29 thus determines the value of illumination control data corresponding to the first illumination device, on the basis of the weighted values of the illumination control data.

Further, when illumination control data externally obtained is attached to each frame of image data, the illumination control data conversion process is repeatedly performed for each frame. This allows generation of suitable illumination control data according to images displayed on the image display screen.

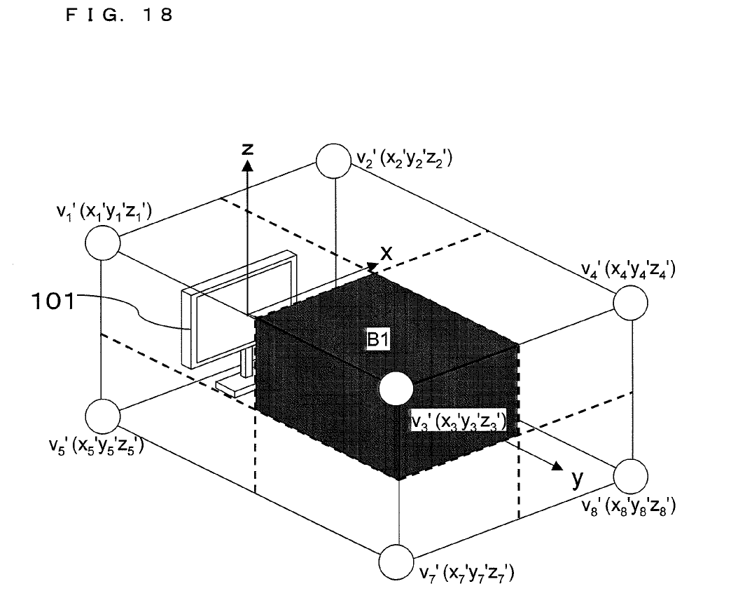

The present conversion method determines illumination control data for a specific illumination device installed in the actual audio-visual environment space, on the basis of the illumination control data corresponding to each of the four illumination devices provided on the surface of the wall in the virtual audio-visual environment space, the wall being positioned closest to the specific illumination device. Alternatively, as illustrated in FIG. 17, illumination control data for a specific illumination device may, for example, be determined based on the illumination control data for each of all the eight illumination devices installed in the eight corners of the virtual audio-visual environment space. In addition, illumination control data for each illumination device installed in the actual audio-visual environment space may also be determined by performing a predetermined interpolation operation on the illumination control data for each of two or more nearby illumination devices in the virtual audio-visual environment space.

The third conversion method described below is an easy method of generating illumination control data, as compared to the above two methods. This method segments a target space into blocks in correspondence with the illumination devices installed in the virtual audio-visual environment space and generates illumination control data on the basis of which block contains each specific illumination device installed in the actual audio-visual environment space.

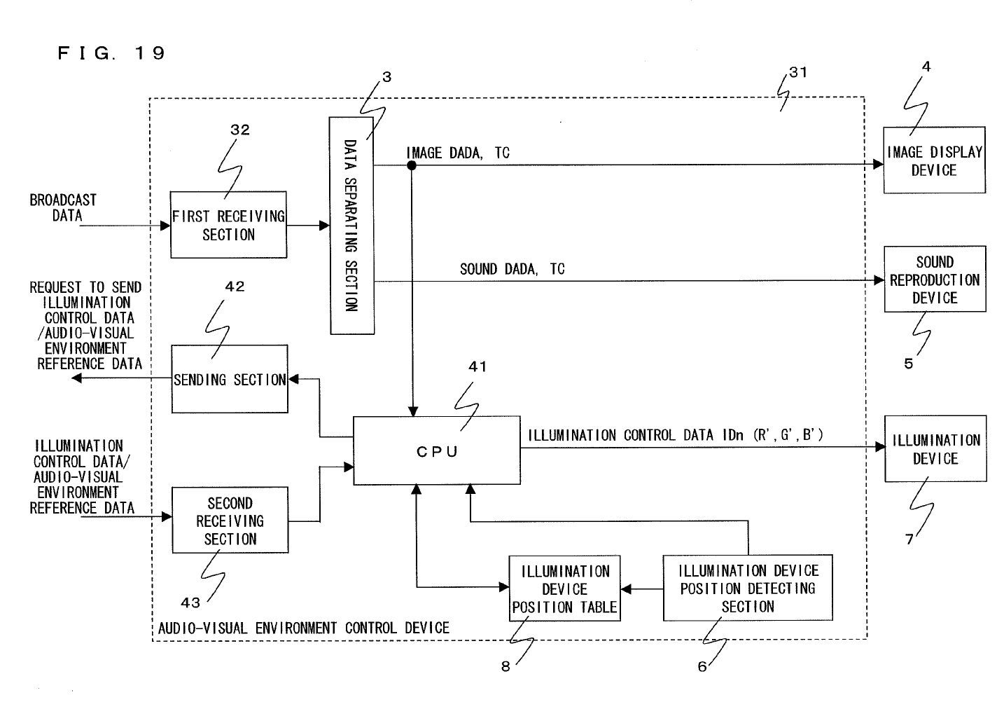

FIG. 18 is a view illustrating a virtual audio-visual environment space containing eight illumination devices v through v8′ in its eight corners, respectively, as in the virtual audio-visual environment space model used in the above two conversion methods. This method segments the virtual audio-visual environment space into eight spaces (blocks). Each of the eight blocks is assigned the illumination value of one of the illumination devices v1′ through v8′, the one being installed in its corner. The block designated as B1 in FIG. 18 is, for example, assigned the illumination value (illumination control data) for the illumination device v3′.

Subsequently, each illumination device installed in the actual audio-visual environment space is positioned in the virtual audio-visual environment space set as above. This allows each specific illumination device provided in the actual audio-visual environment space to be assigned the illumination value (illumination control data) that is assigned to the block containing the light source of the specific illumination device.

In other words, the illumination control data converting section 29, with use of audio-visual environment reference data and illumination control data corresponding to the audio-visual environment reference data, both received by the receiving section 22, assigns the illumination control data for an illumination device to each of the divisional spaces formed by division of the virtual audio-visual environment space into multiple spaces each containing an illumination device. The illumination control data converting section 29 then assigns the illumination control data, which is assigned to a specific divisional space, to each actual illumination device that is contained in the specific divisional space when the virtual audio-visual environment space is superposed upon the actual audio-visual environment space indicated by illumination device position data stored in the illumination device position table 8.

This method of generating illumination control data eliminates the need to perform a complex operation and also allows suitable control of each illumination device in the actual audio-visual environment space. When the actual audio-visual environment space is larger then the virtual audio-visual environment space and therefore an illumination device installed in the actual audio-visual environment space lies outside the virtual audio-visual environment space, the eight divisional spaces may be extended so that the space containing such an illumination device is determined.

The above description of the methods of converting illumination control data in accordance with the present embodiment deals with the case in which illumination control data and audio-visual environment reference data are attached to image data when sent. The present invention is also applicable to the case in which illumination control data is multiplexed in broadcast waves when sent, whereas audio-visual environment reference data is obtainable from, for example, an external server via the Internet, and even to the case in which the image display device 4 is moved.

### Third Embodiment

The present invention may also be achieved by: temporarily sending illumination device position data stored in the illumination device position table to an external server via, for example, the Internet; generating illumination control data in the server in accordance with how each illumination device is installed in the audio-visual environment space for a viewer; and receiving such illumination control data via, for example, the Internet so that the illumination control data thus generated is used as illumination control data for each illumination device. This is described below as the third embodiment of the present invention. It should be noted that identical members between the first and third embodiments are represented by the same reference numerals and that the description of such members is omitted.

FIG. 19 is a block diagram illustrating an audio-visual environment control device according to the third embodiment of the present invention. The audio-visual environment control device 31 of the present embodiment causes a first receiving section 32 to receive broadcast data sent from a sender (broadcast station) and also causes a data separating section 3 to separate the broadcast data into image data and sound data, which are multiplexed in the broadcast data. The image data and the sound data obtained as a result of the separation by the data separating section 3 are sent to an image display device 4 and a sound reproduction device 5, respectively.

Subsequently, an illumination device position detecting section 6 receives illumination light from at least one illumination device 7 installed in an audio-visual environment space and labeled in advance with an identifier (hereinafter referred to as “ID”), detects the installation position of each illumination device 7 on the basis of the illumination light, and sends data (illumination device position data) on the thus-detected installation position of each illumination device 7 to an illumination device position table 8.

The illumination device position table 8 stores the illumination device position data in a table format by ID of each illumination device 7. In response, for example, to an instruction from a user, a CPU 41 notifies an external server via a sending section 42 of a request to send illumination control data for a program content to be displayed by the image display device 4. Further, in response to an instruction from the CPU 41, illumination device position data stored in the illumination device position table 8 is also sent to the external server via the sending section 42.

The external server generates the requested illumination control data for the program content on the basis of the illumination device position data and then sends the illumination control data to the requestor, i.e., to the audio-visual environment control device. The illumination control data sent from the external server is received by a second receiving section 43 and is then temporarily held in the CPU 41.

The CPU 41 next sends to each illumination device 7 the illumination control data, which corresponds to the time code (TC) of the image data obtained as a result of the separation by the data separating section 3. In other words, the illumination control data sent from the external server is described for each frame in association with the time code (TC) of the image data so as to be capable of being outputted in synchronization with the output timing of the image data.

The operation by the illumination device position detecting section 6 is the same as that in the first embodiment described above. The description of the operation is therefore omitted here. Further, it is possible to understand that the function by the illumination control data converting section 29 in the second embodiment is provided in an external device in the present embodiment. In other words, the audio-visual environment control device 31 is capable of obtaining from an external device illumination control data according to the arrangement and number of illumination devices in the actual audio-visual environment space.

Arranging the audio-visual environment control device as described above eliminates the need to provide the function of generating illumination control data from the image feature and/or the sound feature as well as the function of converting illumination control data in accordance with the audio-visual environment, and also allows suitably controlling at least one illumination device 7 installed in an audio-visual environment space, in accordance with the installation position of each illumination device 7. Further, the above arrangement allows suitable illumination control in any case; e.g., in the case where an illumination device 7 is reinstalled at a different position in the audio-visual environment space, in the case where an additional illumination device 7 is provided, or even in the case where the image display device 4 is moved to a different position.

The program content mentioned in the above description is not limited to the content of a TV program transmitted by TV broadcasting; therefore, it may be the content of a production stored in a medium such as a DVD. In other words, the image data to be inputted is not necessarily obtained by reception of a TV broadcast. Thus, the present invention is applicable even when reproduced image data is inputted from an external reproduction device.

Further, the program content refers to a set of data at least including image data and normally including sound data in addition to such image data. In other words, the program content refers to a set of data including image data as well as sound data corresponding to the image data.

As described above, the audio-visual environment control device of the present invention may be arranged such that the illumination device position detecting means includes: a control section for controlling each of the at least one illumination device to be independently and sequentially turned on or off; and an optical sensor section for detecting a direction and an intensity of illumination light from each of the at least one illumination device which has been controlled to be turned on by the control section, the information, stored by the storing means, being obtained in accordance with the direction and the intensity detected by the optical sensor section.

An audio-visual environment control system of the present invention includes: the audio-visual environment control device; a display device for displaying the image data; and an illumination device provided around the display device.

The audio-visual environment control system of the present invention may be arranged such that the illumination device position detecting means is provided to the display device.

The audio-visual environment control system of the present invention may be arranged such that the illumination device position detecting means includes: a control section for controlling each of the at least one illumination device to be independently and sequentially turned on or off; and an optical sensor section for detecting a direction and an intensity of illumination light from each of the at least one illumination device which has been controlled to be turned on by the control section, the information, stored by the storing means, being obtained in accordance with the direction and the intensity detected by the optical sensor section.

An audio-visual environment control system of the present invention includes: the audio-visual environment control device; a display device for displaying input image data; and an illumination device provided around the display device.

The audio-visual environment control system of the present invention may be arranged such that the illumination device position detecting means is provided to the display device.

The audio-visual environment control device of the present invention may be arranged such that the illumination device position detecting means includes: a control section for controlling each of the at least one illumination device to be independently and sequentially turned on or off; and an optical sensor section for detecting a direction and an intensity of illumination light from each of the at least one illumination device which has been controlled to be turned on by the control section, the information, sent by the sending means, being obtained in accordance with the direction and the intensity detected by the optical sensor section.

An audio-visual environment control system of the present invention includes: the audio-visual environment control device; a display device for displaying input image data; and an illumination device provided around the display device.

The audio-visual environment control system of the present invention may be arranged such that the illumination device position detecting means is provided to the display device.

### Reference Signs List

1, 21, 31 audio-visual environment control device
2, 22 receiving section
3, 23 data separating section
4 image display device
5 sound reproduction device
6 illumination device position detecting section
6a optical sensor
6b control section
7 illumination device
8 illumination device position table
9 illumination control data generating section
29 illumination control data converting section
10(a), 10(b), 30(a), 30(b) delay generating section
14 light-receiving elements
41 CPU
42 sending section
32 first receiving section
43 second receiving section

1. An audio-visual environment control device for controlling illumination light from at least one illumination device in accordance with features of image data to be displayed by a display device, the audio-visual environment control device comprising:
illumination device position detecting means for detecting each installation position of the at least one illumination device;
storing means for storing information on the each installation position detected by the illumination device position detecting means; and
illumination data generating means for generating, in accordance with features of image data, illumination control data for controlling each of the at least one illumination device, the features being extracted in accordance with the information stored by the storing means.

2. The audio-visual environment control device according to claim 1, wherein
the illumination device position detecting means includes:
a control section for controlling each of the at least one illumination device to be independently and sequentially turned on or off; and
an optical sensor section for detecting a direction and an intensity of illumination light from each of the at least one illumination device which has been controlled to be turned on by the control section,
the information, stored by the storing means, being obtained in accordance with the direction and the intensity detected by the optical sensor section.

3. An audio-visual environment control device for controlling, in accordance with features of an image to be displayed by a display device, illumination light from at least one illumination device provided in an audio-visual space in which the display device is provided, the audio-visual environment control device comprising:
illumination device position detecting means for detecting each installation position of the at least one illumination device; and
illumination data generating means for (i) extracting features in a partial region of an image, the partial region corresponding to the each installation position detected by the illumination device position detecting means and (ii) generating illumination control data for controlling each of the at least one illumination device in accordance with the features thus extracted.

4. An audio-visual environment control system, comprising:
an audio-visual environment control device recited in any one of claims 1 to 3;
a display device for displaying the image data; and
an illumination device provided around the display device.

5. The audio-visual environment control system according to claim 4, wherein the illumination device position detecting means is provided to the display device.

6. An audio-visual environment control device for controlling illumination light from at least one illumination device in accordance with (i) reference data, obtained from an external device, on an illumination device position in an virtual audio-visual environment space and (ii) illumination control data, obtained from an external device, corresponding to the illumination position in the virtual audio-visual environment space, the audio-visual environment control device comprising:
illumination device position detecting means for detecting each installation position of the at least one illumination device;
storing means for storing information on the each installation position detected by the illumination device position detecting means; and
illumination data converting means for converting, in accordance with (i) the information stored in the storing means and (ii) the reference data, the illumination control data into illumination control data for controlling each of the at least one illumination device.

7. The audio-visual environment control device according to claim 6, wherein
the illumination device position detecting means includes:
a control section for controlling each of the at least one illumination device to be independently and sequentially turned on or off; and
an optical sensor section for detecting a direction and an intensity of illumination light from each of the at least one illumination device which has been controlled to be turned on by the control section,
the information, stored by the storing means, being obtained in accordance with the direction and the intensity detected by the optical sensor section.

8. An audio-visual environment control device, comprising:
receiving means for receiving, (i) reference data indicating an arrangement in which at least one illumination device is provided in an virtual space and (ii) illumination control data for controlling illumination light from each of the at least one illumination device having the arrangement indicated by the reference data, so as to cause the reference data and the illumination control data to be correlated with each other;
illumination device position detecting means for detecting a position of an illumination device provided in an actual space; and
illumination control data converting means for converting the illumination control data received by the receiving means so that an illumination effect, similar to an illumination effect that is obtained in a case where the illumination light from each of the at least one illumination device having the arrangement indicated by the reference data received by the receiving means is controlled, is obtained in a case where the illumination device is provided at the position detected by the illumination device position detecting means.

9. An audio-visual environment control system, comprising:
an audio-visual environment control device recited in any one of claims 6 to 8;
a display device for displaying input image data; and
an illumination device provided around the display device.

10. The audio-visual environment control system according to claim 9, wherein the illumination device position detecting means is provided to the display device.

11. An audio-visual environment control device for controlling illumination light from at least one illumination device in accordance with illumination control data obtained from an external device, the audio-visual environment control device comprising:
illumination device position detecting means for detecting each installation position of the at least one illumination device;
sending means for sending, to the external device, information on the each installation position detected by the illumination device position detecting means; and
receiving means for receiving illumination control data generated by the external device in accordance with the information on the each installation position of the at least one illumination device.

12. The audio-visual environment control device according to claim 11, wherein
the illumination device position detecting means includes:
a control section for controlling each of the at least one illumination device to be independently and sequentially turned on or off; and
an optical sensor section for detecting a direction and an intensity of illumination light from each of the at least one illumination device which has been controlled to be turned on by the control section,
the information, sent by the sending means, being obtained in accordance with the direction and the intensity detected by the optical sensor section.

13. An audio-visual environment control system, comprising:
an audio-visual environment control device recited in claim 11 or 12;
a display device for displaying input image data; and
an illumination device provided around the display device.

14. The audio-visual environment control system according to claim 13, wherein the illumination device position detecting means is provided to the display device.

15. An audio-visual environment control method for controlling illumination light from at least one illumination device in accordance with features of image data to be displayed by a display device, the audio-visual environment control method comprising the steps of:
(i) detecting each installation position of the at least one illumination device;
(ii) storing information on the each installation position detected in the step (i); and
(iii) generating, in accordance with features of image data, illumination control data for controlling each of the at least one illumination device, the features being extracted in accordance with the information on the each installation position, the information being stored in the step (ii).

16. An audio-visual environment control method for controlling illumination light from at least one illumination device in accordance with (i) reference data, obtained from an external device, on an illumination device position in an virtual audio-visual environment space and (ii) illumination control data, obtained from an external device, corresponding to the illumination position in the virtual audio-visual environment space, the audio-visual environment control method comprising the steps of:
(i) detecting each installation position of the at least one illumination device;
(ii) storing information on the each installation position detected in the step (i); and
(iii) converting, in accordance with (a) the information stored in the step (ii) and (b) the reference data, the illumination control data, into illumination control data for controlling each of the at least one illumination device.

17. An audio-visual environment control method for controlling illumination light from at least one illumination device in accordance with illumination control data obtained from an external device, the audio-visual environment control method comprising the steps of:
(i) detecting each installation position of the at least one illumination device;
(ii) sending means for sending, to the external device, information on the each installation position detected in the step (i); and
(iii) receiving illumination control data generated by the external device in accordance with the information on the each installation position of the at least one illumination device.
